(19) United States
(12) Patent Application Publication
(10) Pub. No.: US 2003/0199198 A1
(43) Pub. Date: Oct. 23, 2003

(54) Fuse holding and securing assembly

(76) Inventor: Jung Sheng Ku, Chong Ho City (TW)

Correspondence Address: Jung Sheng Ku, Chong Ho, P.O. Box 10-69, Taipei, 235, TW

(21) Appl. No.: 09/863,916

(22) Filed: May 21, 2001

(51) Int. Cl. H01R 13/68

(52) U.S. Cl. 439/621

(57) ABSTRACT

A fuse device includes a base, two conductor blades secured to the base and extended outward of the base and each having a groove formed between two ears. A fuse member has two ends engaged into the grooves of the conductor blades. The conductor extensions include a non-circular cross section for securing or plugging or attaching to the other sockets or objects. The conductor blades each includes an opening communicating with the grooves for receiving the ends of the fuse member. A cover is secured to the base for shielding the fuse member and the conductor blades.

### BACKGROUND OF THE INVENTION

1. Field of the Invention

The present invention relates to a fuse, and more particularly to a fuse holding and securing assembly.

2. Description of the Prior Art

As shown in FIG. 1, a typical fuse holding and securing assembly is shown and comprises two pairs of conductor blades 11, 12 provided on a base 10 for receiving and engaging with and retaining the ends 16 of a cartridge fuse member 14 and for electrically coupling and securing the cartridge fuse member 14 on the base 10. The typical fuse holding and securing assembly includes a complicated configuration that is expensive and that may not firmly or solidly securing the cartridge fuse member 14 on the base 10 with the conductor blades 11, 12. In addition, the ends of the cartridge fuse member 14 include a cylindrical shape that may not be plugged to the other sockets and that may not be secured to the other objects with welding operations.

The present invention has arisen to mitigate and/or obviate the afore-described disadvantages of the conventional fuses.

### SUMMARY OF THE INVENTION

The primary objective of the present invention is to provide a fuse holding and securing assembly including a greatly simplified configuration for greatly reducing the manufacturing fees or costs for the fuse.

The other objective of the present invention is to provide a fuse holding and securing assembly including a greatly simplified configuration for allowing the fuse member to be easily and quickly secured on the supporting base.

In accordance with one aspect of the invention, there is provided a fuse securing assembly comprising a base, two conductor blades secured to the base and extended outward of the base, the conductor blades each including a groove formed therein, and a fuse member including two ends engaged into the grooves of the conductor blades for securing to the conductor blades.

The conductor blades each includes an opening formed therein and communicating with the grooves thereof respectively for receiving the ends of the fuse member.

The conductor blades each includes a conductor extension extended outward of the base. The base includes an upper portion and a bottom portion, the conductor blades are extended outward from the upper portion of the base, and the conductor extensions are extended outward from the bottom portion of the base. The conductor extensions preferably include a non-circular cross section for allowing the conductor extensions to be easily secured or plugged or attached to the other sockets, or objects, or the like.

A cover is further secured to the base for shielding the fuse member and the conductor blades.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a typical fuse holding and securing assembly;

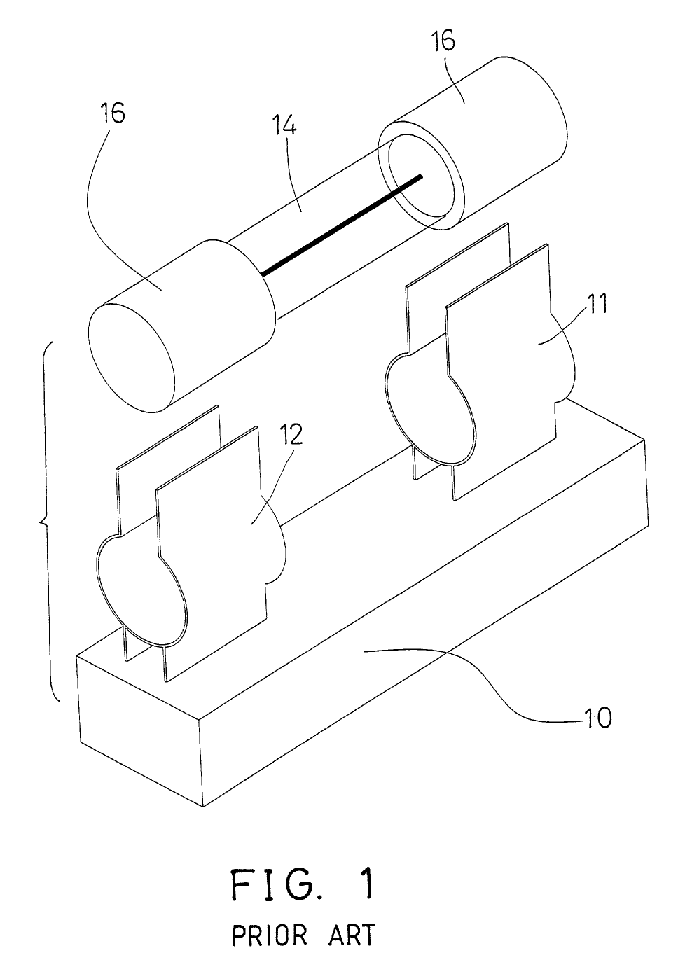

FIG. 2 is a partial perspective view of a fuse holding and securing assembly in accordance with the present invention;

FIG. 3 is a partial exploded view of the fuse holding and securing assembly;

FIG. 4 is a partial perspective view similar to FIG. 2, in which the cover has been removed from the base of the fuse holding and securing assembly;

FIGS. 5, 6, 7, 8 are partial perspective views similar to FIG. 4, illustrating the other embodiments of the fuse holding and securing assembly;

FIG. 9 is a partial exploded view illustrating the other embodiment of the fuse holding and securing assembly; and

FIG. 10 is a perspective view illustrating the further embodiment of the fuse holding and securing assembly.

### DETAILED DESCRIPTION OF THE PREFERRED EMBODIMENT

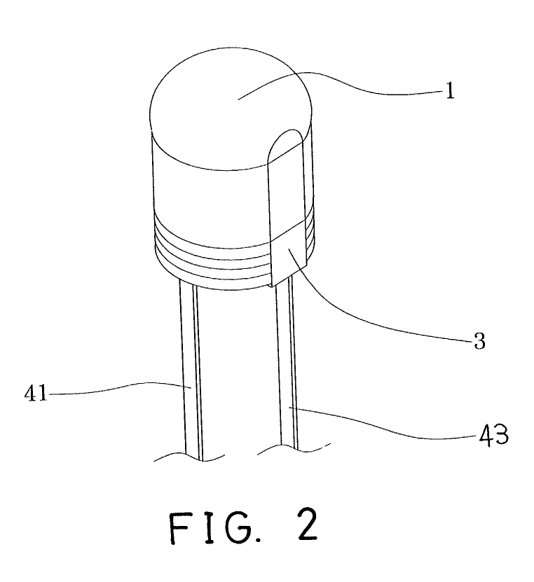

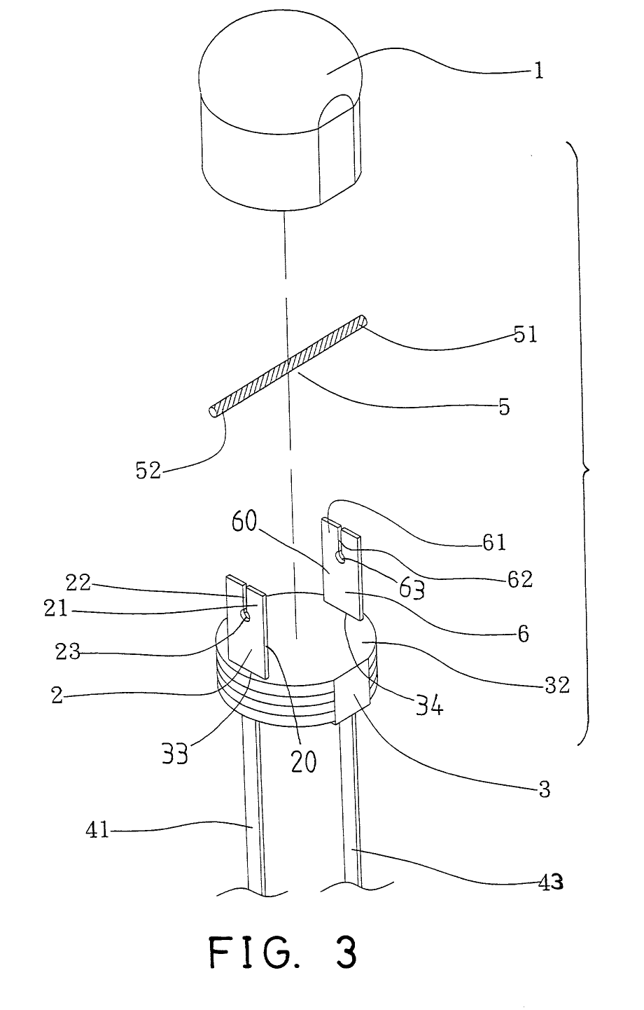

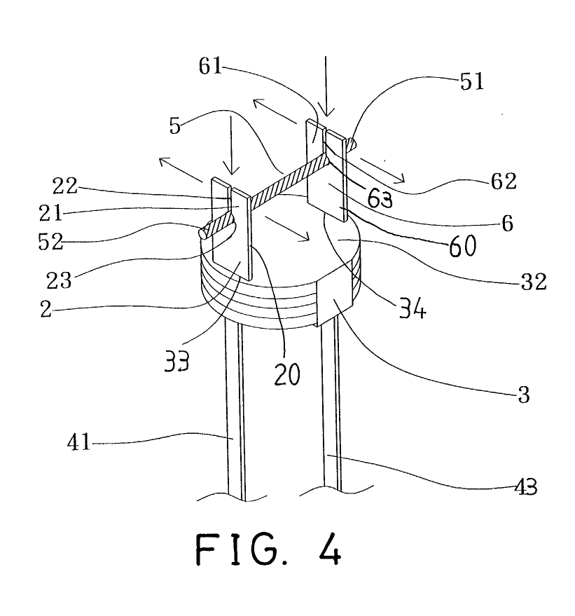

Referring to the drawings, and initially to FIGS. 2-4, a fuse holding and securing assembly in accordance with the present invention comprises a base 3 including an upper portion 32, and including two slots 33, 34 formed therein and formed through the base 3. Two conductor blades 2, 6 are engaged in the slots 33, 34 of the base 3 and each includes one end 20, 60 extended upward of the upper portion 32 of the base 3, and each includes a conductor extension 41, 43 extended downward beyond or out of the bottom portion of the base 3. The conductor extensions 41, 43 each preferably includes a non-circular cross section, or a polygonal cross section for facilitating the securing or the plugging or the engaging of the conductor extensions 41, 43 with the other sockets or engaging members or the like.

The one ends 20, 60 of the conductor blades 2, 6 each includes a free end portion having a pair of resilient flaps or ears 21, 61 formed therein, and having a groove 22, 62 formed or defined between the pairs of ears 21, 61, and having an opening 23, 63 formed in the root portion of the grooves 22, 62 respectively. A fuse member 5 includes two ends 51, 52 engaged into the openings 23, 63 of the ends 20, 60 of the conductor blades 2, 6 via the grooves 22, 62 of the conductor blades 2, 6. The ends 51, 52 of the fuse member 5 include a width or a diameter greater than that of the grooves 22, 62 and the openings 23, 63 of the conductor blades 2, 6, such that the ends 51, 52 of the fuse member 5 may be clamped and secured to the ends 20, 60 of the conductor blades 2, 6. The resilient ears 21, 61 may be biased or moved away from each other when the ends 51, 52 of the fuse member 5 are engaged into the grooves 22, 62 of the ends 20, 60 of the conductor blades 2, 6, and may clamp the ends 51, 52 of the fuse member 5 in the ends 20, 60 of the conductor blades 2, 6 when the ends 51, 52 of the fuse member 5 are engaged within the openings 23, 63 of the ends 20, 60 of the conductor blades 2, 6. A cover 1 may be secured onto the base 3 with a threading engagement, or with an adhesive material, or by a welding process, or the like.

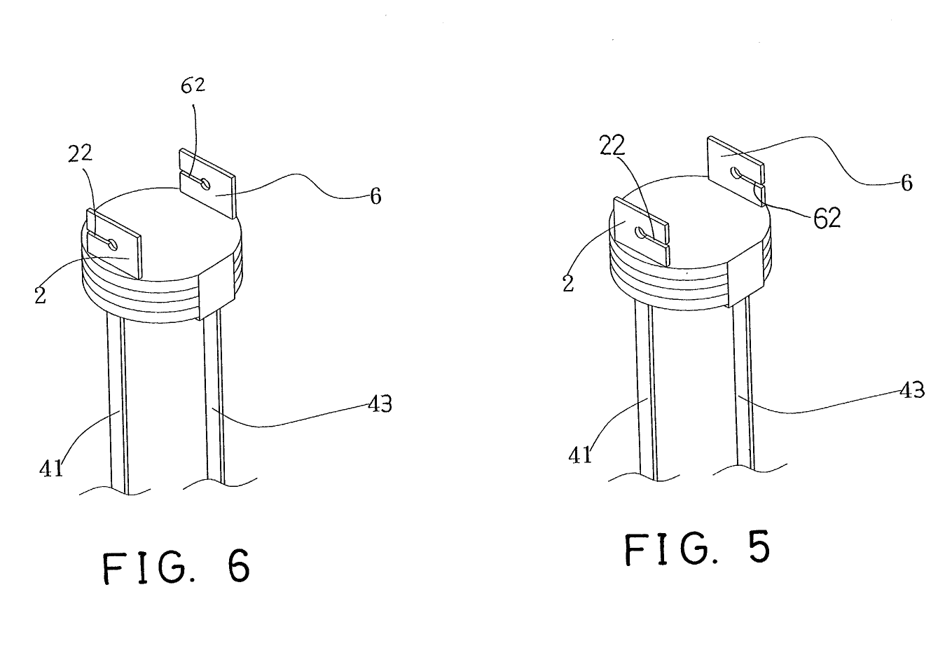

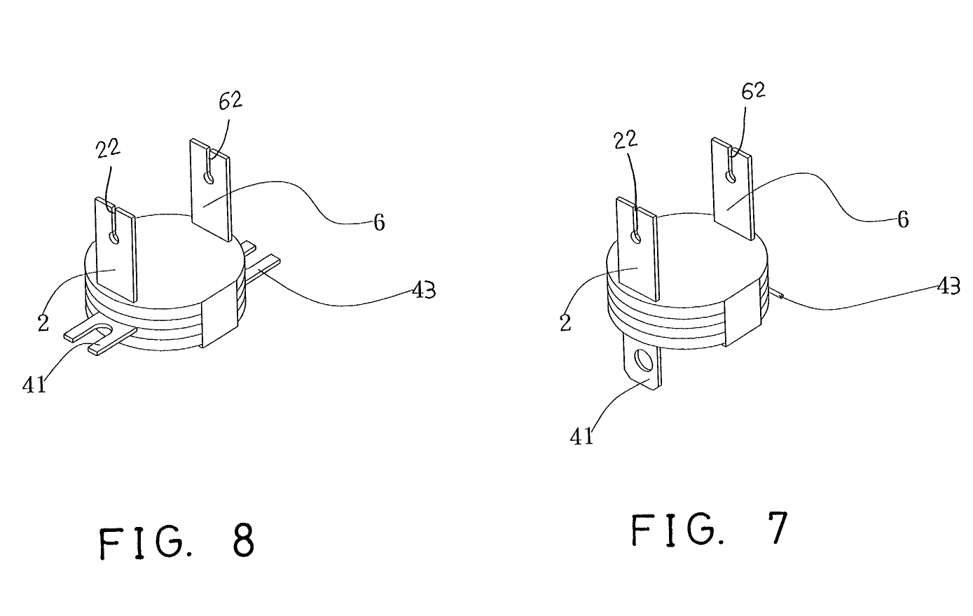

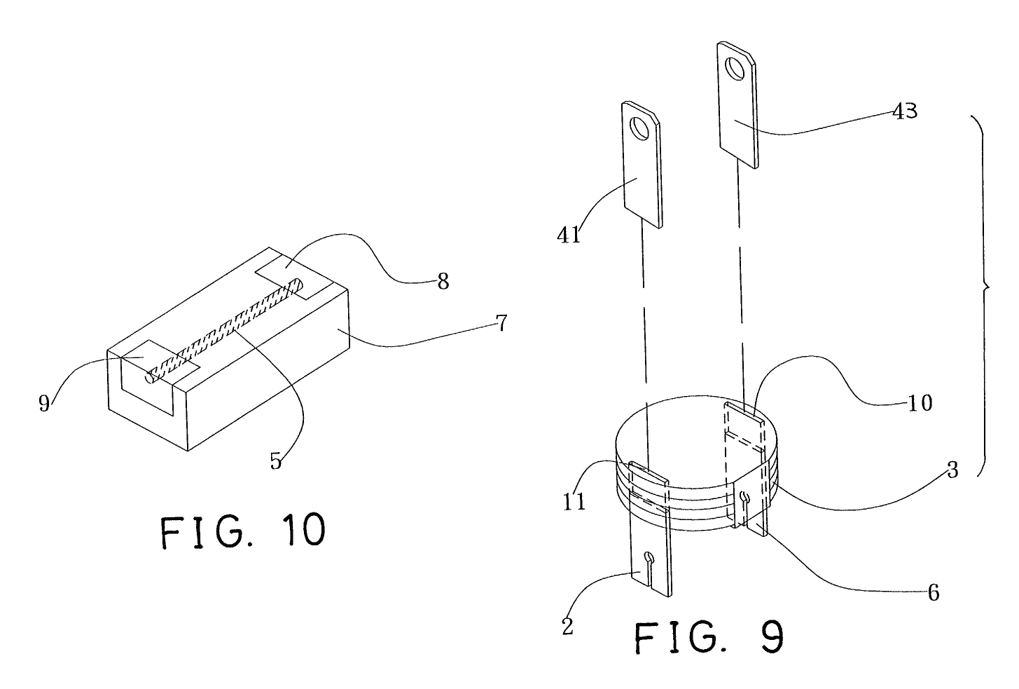

Referring next to FIGS. 5-8, the grooves 22, 62 of the conductor blades 2, 6 may be directed toward different directions. The conductor extensions 41, 43 may include different shapes or cross sections, for easily plugging to the other objects, or for easily securing to the objects with the welding processes or the like. Referring next to FIG. 9, the conductor extensions 41, 43 may be separated from the conductor blades 2, 6 and may be engaged into the slots 33, 34 of the base 3 for electrically coupling to the conductor blades 2, 6 respectively. Referring next to FIG. 10, the fuse member 5 may also be secured in a casing 7, and two conductor members 8, 9 provided on the ends of the casing 7 and electrically coupled to the ends of the fuse member 5 for electrically plugging or coupling or securing to the other objects.

In operation, as shown in FIG. 2, the conductor extensions 41, 43 may be used for easily securing to or plugging to or coupling to the other objects, such as the sockets, and the like.

Accordingly, the fuse holding and securing assembly in accordance with the present invention includes a greatly simplified configuration for greatly reducing the manufacturing fees or costs for the fuse, for allowing the fuse member to be easily and quickly secured on the supporting base.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fuse securing assembly comprising:
a base,
two conductor blades secured to said base and extended outward of said base, said conductor blades each including a groove formed therein, and
a fuse member including two ends engaged into said grooves of said conductor blades for securing to said conductor blades.

2. The fuse securing assembly according to claim 1, wherein said conductor blades each includes an opening formed therein and communicating with said grooves thereof respectively for receiving said ends of said fuse member.

3. The fuse securing assembly according to claim 1, wherein said conductor blades each includes a conductor extension extended outward of said base.

4. The fuse securing assembly according to claim 3, wherein said base includes an upper portion and a bottom portion, said conductor blades are extended outward from said upper portion of said base, and said conductor extensions are extended outward from said bottom portion of said base.

5. The fuse securing assembly according to claim 1 further comprising a cover secured to said base for shielding said fuse member and said conductor blades.
